(19) United States
(12) Patent Application Publication
(10) Pub. No.: US 2024/0403458 A1
(43) Pub. Date: Dec. 5, 2024

(54) FILE PROTECTION USING EVALUATION OF FILE-SPECIFIC VALUES

(71) Applicant: Dell Products L.P., Round Rock, TX (US)

(72) Inventors: Roman Bober, Ha Darom (IL); Stav Sapir, Beer Sheba (IL); Maxim Balin, Gan-Yavne (IL)

(21) Appl. No.: 18/326,258

(22) Filed: May 31, 2023

(51) Int. Cl. G06F 21/62; G06F 21/60

(52) U.S. Cl. CPC G06F 21/6209; G06F 21/602; G06F 21/604

(57) ABSTRACT

Techniques are provided for file protection using evaluation of file-specific values. One method comprises obtaining, by an entity of a device, at least a portion of a file to be written to the device; obtaining, by the entity, a file-specific value associated the portion of the file; comparing, by the entity, the file-specific value to a list of designated values; and initiating, by the entity, an automated action based on a result of the comparison. The file-specific value may comprise a hash value calculated in response to receiving a request to write the portion of the file to the device. The file may comprise a template for a virtual machine and/or a container. The automated action May comprise generating a notification; deleting the portion of the file from the device; preventing access to the portion of the file; and/or limiting access to the portion of the file.

### FIELD

The field relates generally to information processing, and more particularly to protecting devices in information processing systems.

### BACKGROUND

Information processing systems increasingly utilize virtual resources to meet changing user needs in an efficient, flexible and cost-effective manner. For example, cloud computing systems implemented using virtual resources, such as virtual machines and containers, have been widely adopted. Significant challenges may arise when downloading templates for such virtual resources and other files to devices. For example, such downloaded files may comprise malicious or unauthorized software that may interfere with computer system operations, permit unauthorized access to computer systems, acquire private or otherwise sensitive information or perform other harmful operations.

### SUMMARY

In one embodiment, a method comprises obtaining, by at least one entity associated with an operating system of at least one processing device, at least a portion of a file to be written to the at least one processing device; obtaining, by the at least one entity, at least one file-specific value associated with the at least a portion of the file; comparing, by the at least one entity, the at least one file-specific value to at least one value from a list of designated values; and initiating, by the at least one entity, at least one automated action based at least in part on a result of the comparison.

In some embodiments, the at least one automated action may comprise writing the at least a portion of the file to at least one file system; generating at least one notification; deleting the at least a portion of the file from a file system of the at least one processing device; preventing access to the at least a portion of the file; and/or limiting access to the at least a portion of the file.

In one or more embodiments, the at least one file-specific value associated with the at least a portion of the file comprises a hash value calculated in response to receiving a request to write the at least a portion of the file to the at least one processing device. The file may comprise a template for one or more of a virtual machine and a container, and the template may be stored in an inventory of the at least one processing device. The list may comprise a list of file-specific values associated with one or more designated files.

In at least one embodiment, the at least one entity obtains the at least a portion of the file to be written to the at least one processing device by intercepting a request to write the at least a portion of the file to the at least one processing device. The at least one entity associated with the operating system may comprise at least one software entity associated with an operating system kernel. The at least one processing device may comprise a host device and/or at least one virtual resource executing on a hypervisor.

These and other illustrative embodiments include, without limitation, methods, apparatus, networks, systems and processor-readable storage media.

### BRIEF DESCRIPTION OF THE DRAWINGS

FIG. 1 is a block diagram of an information processing system that provides file protection using evaluation of file-specific values in an illustrative embodiment;

FIG. 2 illustrates the kernel-level write interception and verification module of FIG. 1 in further detail in an illustrative embodiment;

FIGS. 3 and 4 illustrate portions of the information processing system of FIG. 1 in further detail in illustrative embodiments;

FIG. 5 is a flow diagram illustrating an exemplary implementation of a file protection process using write operation interception and file verification in an illustrative embodiment; and

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

A virtualization platform enables customers to execute virtual resources such as virtual machines and/or containers. Automation systems, such as orchestration engines, often seek to deploy workloads to host devices and/or the virtualization platform. Such automation systems, however, are often unable to prevent malicious or unauthorized software from being downloaded as part of a file or template (e.g., from a registry). Unauthorized images can be created by malicious actors who may have tampered with the original images in order to insert malicious or other unauthorized code. An unauthorized image may contain a “back door,” for example, that allows an attacker to gain unauthorized access to sensitive data or systems. In addition, an image comprising malicious code may be used to launch a Denial-of-Service (DOS) attack, where an attacker creates multiple containers from a malicious image in order to overload a target system and disrupt service availability.

While one or more embodiments are described herein in the context of verification of templates and/or images associated with virtual resources, such as virtual machines and/or containers, the disclosed techniques for file protection using evaluation of file-specific values can be used to verify any file (or portions thereof) that is being downloaded to a given device, as would be apparent to a person of ordinary skill in the art.

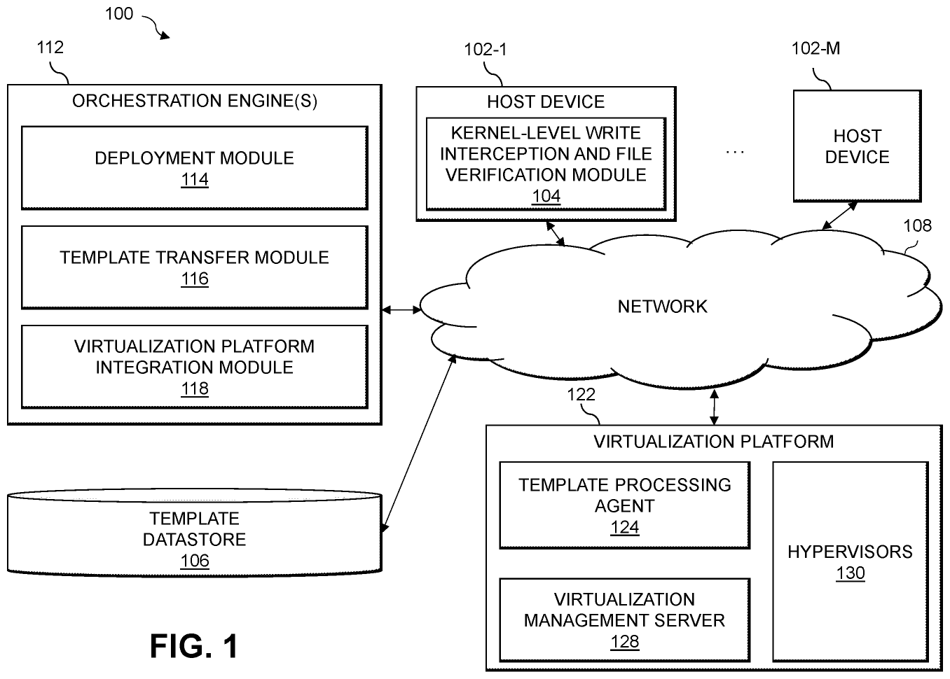

FIG. 1 shows an information processing system 100 configured in accordance with an illustrative embodiment to protect files using write operation interception and file verification. The information processing system 100 comprises one or more host devices 102-1 through 102-M (collectively, host devices 102) and an orchestration engine 112 that communicate over a network 108 with one or more virtualization platforms 122. The orchestration engine 112 may deploy one or more virtual machines applications to one or more of the host devices 102 and/or the virtualization platform 122.

The host devices 102, orchestration engine 112 and/or virtualization platform 122 illustratively comprise respective computers, servers or other types of processing devices capable of communicating with one another via the network 108. For example, at least a subset of the host devices 102 may be implemented as respective virtual machines of a compute services platform or other type of processing platform. The host devices 102 in such an arrangement illustratively provide compute services such as execution of one or more applications on behalf of each of one or more users associated with respective ones of the host devices 102.

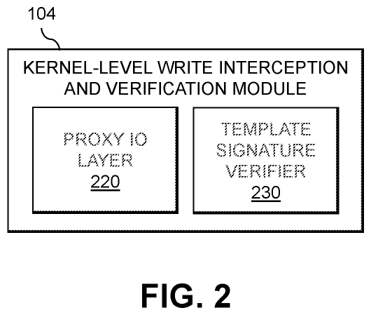

As shown in FIG. 1, one or more of the host devices 102 may comprise a kernel-level write interception and verification module 104. In some embodiments, the kernel-level write interception and verification module 104 detects an operation, request or command, for example, attempting to write a file, such as a virtual resource template, to the respective host device 102, and verifies the file, for example, using an image inspection, as discussed further below in conjunction with FIGS. 2 through 4, for example.

The term “user” herein is intended to be broadly construed so as to encompass numerous arrangements of human, hardware, software or firmware entities, as well as combinations of such entities.

Compute and/or storage services may be provided for users under a Platform-as-a-Service (PaaS) model, a Storage-as-a-Service (STaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be at least partially implemented outside of the cloud infrastructure context, as in the case of a stand-alone computing and storage system implemented within a given enterprise.

In the FIG. 1 embodiment, the orchestration engine 112 further includes a deployment module 114, a template transfer module 116 and a virtualization platform integration module 118. The deployment module 114 is configured in some embodiments to deploy one or more virtual resources (not shown in FIG. 1). The template transfer module 116 may be configured to transfer templates of such virtual resources (e.g., virtual machines and/or containers) to and/or from the host devices 102, virtualization platform 122 and/or a template datastore 106, discussed below. The virtualization platform integration module 118 (which may be implemented, for example, at least in part as a vSphere™ integration service) integrates the orchestration engine 112 with the virtualization platform 122. The orchestration engine 112 may be implemented, for example, at least in part, using the Kubernetes open-source container orchestration system for automating deployment, scaling, and management of containers in cluster. The orchestration engine 112 may provide a centralized management interface for monitoring and controlling the containers in a given cluster.

Images and other templates provide building blocks for container-based orchestration. Images and other templates comprise snapshots of a file system of a container that include the dependencies and configuration information needed to run a specific application or service. When a container is created from an image, for example, the container starts with the same file system as the image, allowing for consistency and predictability in the behavior of the container. Such images can be stored in a registry, such as Docker Hub or Google Container Registry, and can be pulled and run on any machine that has a container runtime, such as Docker or container.

At least portions of the functionality of the deployment module 114, the template transfer module 116 and/or the virtualization platform integration module 118 may be implemented at least in part in the form of software that is stored in memory and executed by a processor.

The virtualization platform 122, as shown in FIG. 1, comprises a template processing agent 124, a virtualization management server 128 and one or more hypervisors 130. The exemplary template processing agent 124 processes templates, such as obtaining one or more needed virtual resource templates that are not available to the virtualization platform 122 at the time of a virtual resource deployment, and processing the obtained virtual resource templates to replicate (e.g., clone) a needed virtual resource using the template and associated deployment information, as discussed below. In some embodiments, the exemplary template processing agent 124 may be an agent of the orchestration engine 112. The virtualization management server 128 provides one or more functions for managing at least portions of the virtualization platform 122. In addition, the exemplary virtualization platform 122 further comprises one or more hypervisors 130 to execute one or more deployed virtual resources.

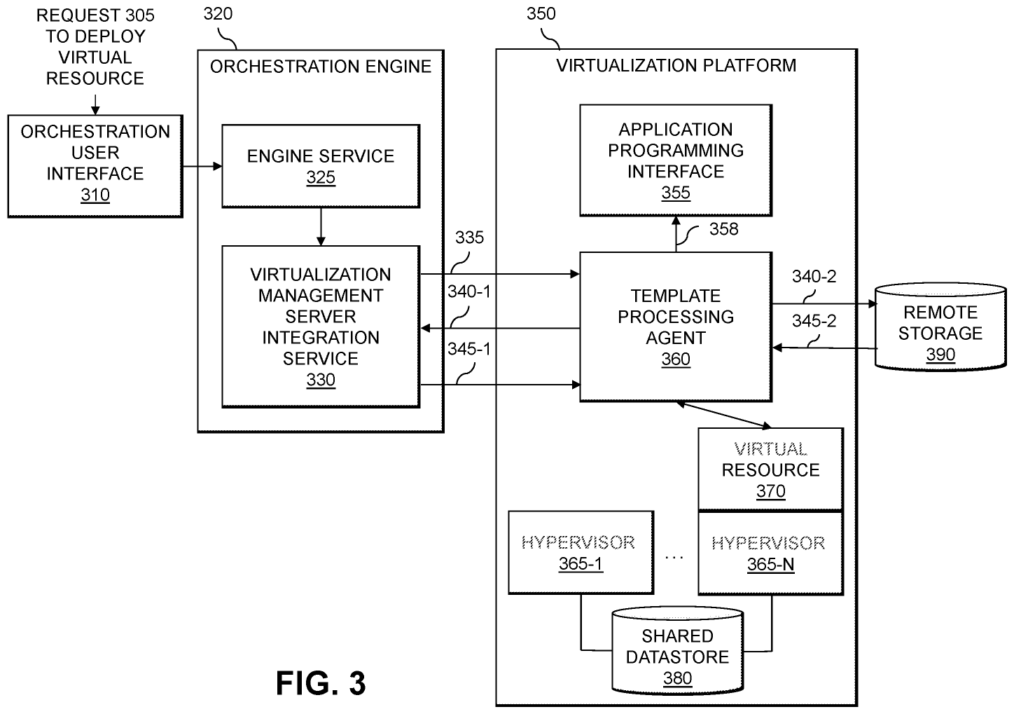

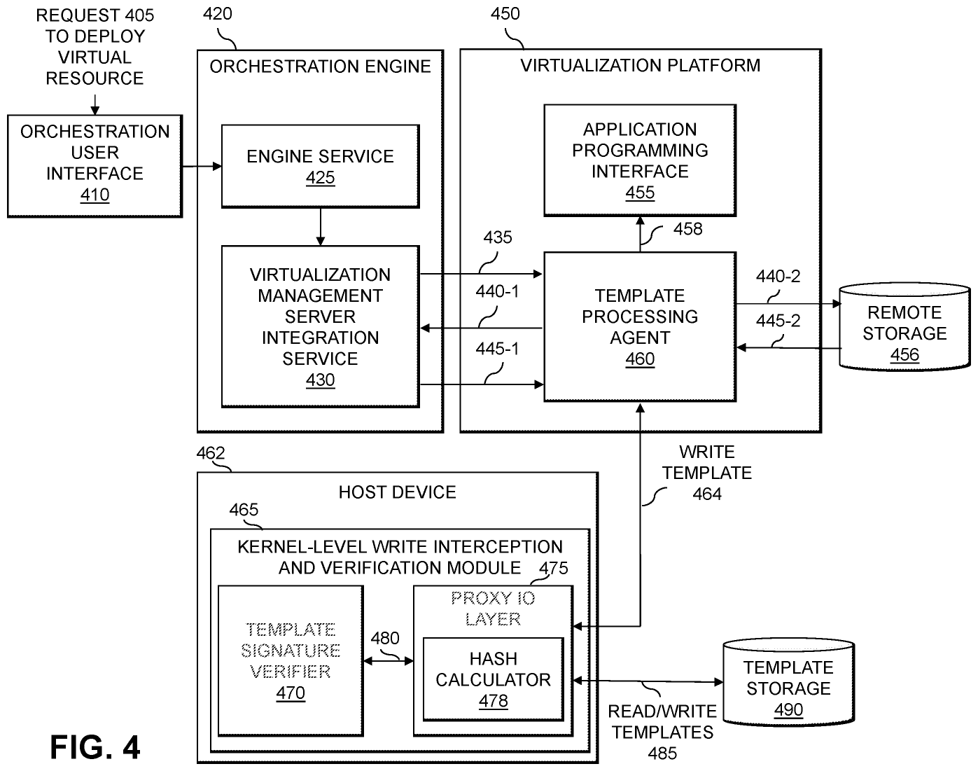

Additionally, the host devices 102, the orchestration engine 112 and/or the virtualization platform 122 can have an associated template datastore 106 configured to store virtual resource templates, as discussed further below in conjunction with FIGS. 3 and 4, for example. The template datastore 106 in the present embodiment can be implemented using storage provided by one or more of the host devices 102 and/or a storage system (not shown), or the template datastore 106 can be accessed over the network 108. Such storage systems can comprise any of a variety of different types of storage including network-attached storage (NAS), storage area networks (SANs), direct-attached storage (DAS) and distributed DAS, as well as combinations of these and other storage types, including software-defined storage. While the template datastore 106 is shown in FIG. 1 as a single datastore, the template datastore 106 may be implemented using multiple datastores, as would be apparent to a person of ordinary skill in the art.

The host devices 102, the orchestration engine 112 and/or the virtualization platform 122 in the FIG. 1 embodiment are assumed to be implemented using at least one processing platform, with each processing platform comprising one or more processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The host devices 102, the orchestration engine 112 (or one or more components thereof such as the deployment module 114, template transfer module 116 and/or virtualization platform integration module 118) and the virtualization platform 122 may be implemented on respective distinct processing platforms, although numerous other arrangements are possible. For example, in some embodiments at least portions of one or more of the host devices 102, the orchestration engine 112 and the virtualization platform 122 are implemented on the same processing platform. The orchestration engine 112 and/or the virtualization platform 122 can therefore be implemented at least in part within at least one processing platform that implements at least a subset of the host devices 102.

The network 108 may be implemented using multiple networks of different types to interconnect storage system components. For example, the network 108 may comprise a portion of a global computer network such as the Internet, although other types of networks can be employed, including a wide area network (WAN), a local area network (LAN), a satellite network, a telephone or cable network, a cellular network, a wireless network such as a WiFi or WiMAX network, or various portions or combinations of these and other types of networks. The network 108 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The virtualization platform 122 in some embodiments may be implemented as part of a cloud-based system.

The host devices 102, the orchestration engine 112 and/or the virtualization platform 122 can be part of what is more generally referred to herein as a processing platform comprising one or more processing devices each comprising a processor coupled to a memory. A given such processing device may correspond to one or more virtual machines or other types of virtualization infrastructure such as Docker containers or other types of LXCs. As indicated above, communications between such elements of system 100 may take place over one or more networks.

The term “processing platform” as used herein is intended to be broadly construed so as to encompass, by way of illustration and without limitation, multiple sets of processing devices and one or more associated storage systems that are configured to communicate over one or more networks. For example, distributed implementations of the host devices 102 are possible, in which certain ones of the host devices 102 reside in one data center in a first geographic location while other ones of the host devices 102 reside in one or more other data centers in one or more other geographic locations that are potentially remote from the first geographic location. The virtualization platform 122 and the orchestration engine 112 may be implemented at least in part in the first geographic location, the second geographic location, and one or more other geographic locations. Thus, it is possible in some implementations of the system 100 for different ones of the host devices 102, the orchestration engine 112, and the virtualization platform 122 to reside in different data centers.

Numerous other distributed implementations of the host devices 102, the orchestration engine 112, and/or the virtualization platform 122 are possible. Accordingly, the host devices 102, the orchestration engine 112, and/or the virtualization platform 122 can also be implemented in a distributed manner across multiple data centers.

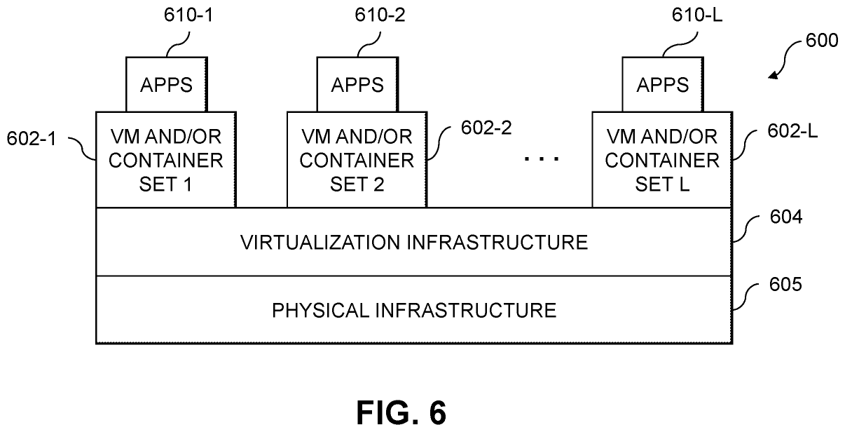

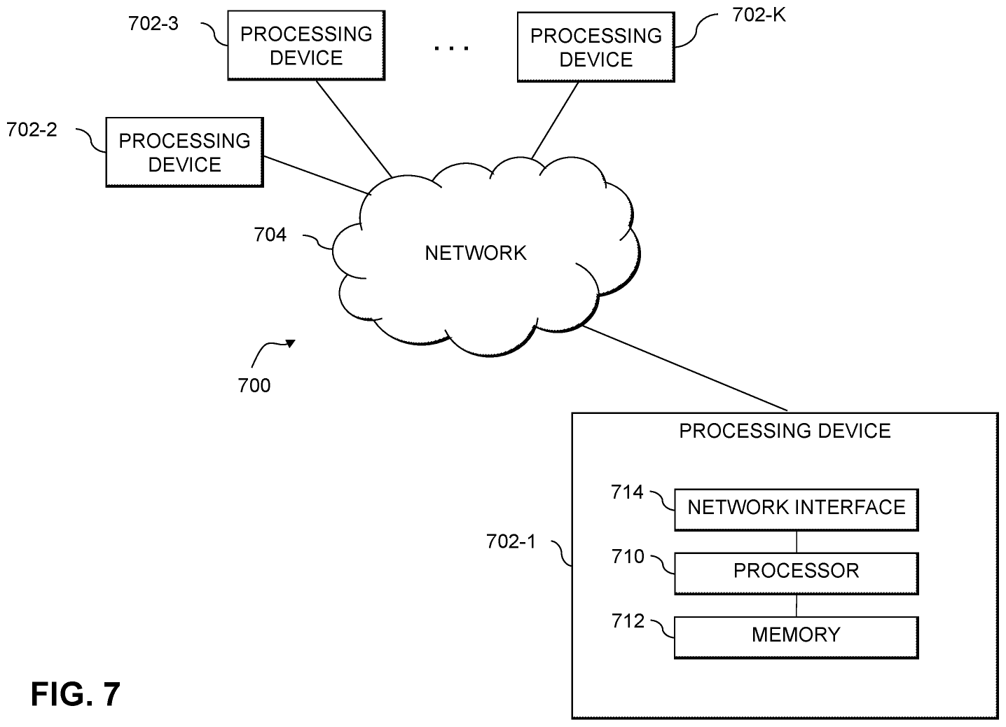

Additional examples of processing platforms utilized to implement portions of the system 100 in illustrative embodiments will be described in more detail below in conjunction with FIGS. 6 and 7.

It is to be understood that the particular set of elements shown in FIG. 1 for file protection using evaluation of file-specific values is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

For example, the particular sets of modules and other components implemented in the system 100 as illustrated in FIG. 1 are presented by way of example only. In other embodiments, only subsets of these components, or additional or alternative sets of components, may be used, and such components may exhibit alternative functionality and configurations.

FIG. 2 illustrates the kernel-level write interception and verification module 104 of FIG. 1 in further detail in an illustrative embodiment. As noted above, the kernel-level write interception and verification module 104 detects an operation, request or command, for example, attempting to write a file, such as a virtual resource template, to the respective host device 102 and verifies the file. In the example of FIG. 2, the kernel-level write interception and verification module 104 comprises a proxy IO (input/output) layer 220 and a template signature verifier 230. The proxy IO layer 220 detects an attempt to write a file, such as a virtual resource template, to the respective host device 102. The template signature verifier 230 verifies the file, for example, by calculating a hash value of the downloaded file (or a portion thereof) and comparing the calculated hash value to a designated list of hash values (e.g., hash values for a list of approved files or a whitelist). The whitelist may be maintained securely with signed entries from a trusted party, identifying images that are authorized on a given host device. If the file verification is not successful, one or more automated actions may be performed as discussed elsewhere herein.

Generally, a kernel is typically resident in the memory of a device, such as one or more of the host devices 102, and provides an interface between software components and hardware components of the device. As used herein, the term “kernel” shall be broadly construed to encompass any computer program that is part of an operating system of a device that enables interactions between such software components, such as applications, and the physical hardware components of the device. The hardware components may comprise, for example, processing components, memory components, storage components and other hardware components.

In one or more embodiments, a software entity associated with the kernel intercepts commands, requests or operations (e.g., prior to the execution of such intercepted commands by the operating system of the respective device), so that a verification of the file may be performed. The kernel may hold such intercepted commands during the evaluation, and only release such intercepted user commands for execution upon a successful verification of the file.

FIG. 3 illustrates portions of the information processing system of FIG. 1 in further detail in an illustrative embodiment. In the example of FIG. 3, a user or a process submits a request 305 to deploy one or more virtual resources 370 using an orchestration user interface 310 of an orchestration engine 320. In response to the request 305 to deploy the one or more virtual resources 370, an engine service 325 of the orchestration engine 320 calls a virtualization management server integration service 330 and provides a template identifier (and/or a storage location) associated with the template and a name of the one or more virtual resources 370 to be created from the template. In some embodiments, the request 305 may also comprise a port group of the virtualization management server integration service 330, a datastore of the virtualization management server integration service 330, and other parameters. The necessary template may be stored, for example, in an inventory of the orchestration engine 320 and/or a network-bound location.

The virtualization management server integration service 330 may be implemented, for example, at least in part as a vSphere™ integration service. The virtualization management server integration service 330 makes a secure connection 335 to a template processing agent 360 of a virtualization platform 350, for example, using mTLS (Mutual Transport Layer Security) and certificates and a software development kit embedded in the virtualization management server integration service 330 to perform the necessary API calls to the template processing agent 360 with the appropriate payloads and parameters.

In some embodiments, the template processing agent 360 can be implemented, for example, using a container and/or a virtual machine and acts as an integration agent for orchestration engine 320.

If the template processing agent 360 determines that the indicated template is not available in the inventory of the virtualization platform 350, the template processing agent 360 will request the template from the orchestration engine 320, using a connection 340-1, or from a remote storage 390 identified by the provided storage location of the template, using a connection 340-2. The orchestration engine 320 and/or the remote storage 390 provide the requested template, using a connection 345-1 or 345-2, respectively. In some embodiments, the contents of the requested template may be signed and verified.

Once the template processing agent 360 obtains the requested template, the template processing agent 360 may cache the requested template and/or upload the requested template into the inventory of the virtualization platform 350, for example, using an application programming interface 355 of the virtualization platform 350 by means of a connection 358.

In addition, the template processing agent 360 replicates (e.g., clones) the obtained template to create a virtual resource 370 to be generated using the deployment information. The created virtual resource 370 executes on one or more of a plurality of hypervisors 365-1 through 365-N (such as VMware™ ESXi™ hypervisors). The hypervisors 365 share a shared datastore 380, for example, to store application information associated with the virtual resource 370 and other applications.

In some embodiments, when the virtual resource 370 is a virtual machine having its own operating system and kernel, the virtual machine may comprise the kernel-level write interception and verification module 104 to perform the disclosed techniques for file protection using evaluation of file-specific values. Similarly, when the virtual resource 370 is a container having libraries that access a kernel that is shared with the host device (e.g., a hypervisor 365), the host device may comprise the kernel-level write interception and verification module 104 to perform the disclosed file protection techniques.

FIG. 4 illustrates portions of the information processing system of FIG. 1 in further detail in an illustrative embodiment. In the example of FIG. 4, a user or a process submits a request 405 to deploy a virtual resource to a host device 462 using an orchestration user interface 410 of an orchestration engine 420. In some embodiments, the user or process that submits the request 405 to deploy the virtual resource using the orchestration user interface 410 may be associated with the host device 462 (e.g., the user or process of the host device 462 may pull a template or image from a repository that results in the requested template or image being written to a disk of the host device 462).

In response to the request 405 to deploy a virtual resource, an engine service 425 of the orchestration engine 420 calls the virtualization management server integration service 430 and provides a template identifier (and/or a storage location) associated with the template and a name of the virtual resource to be created from the template. In some embodiments, the request 405 may also comprise a port group of the virtualization management server integration service 430, a datastore of the virtualization management server integration service 430, and other parameters. The necessary template may be stored, for example, in an inventory of the orchestration engine 420 and/or a network-bound location.

The virtualization management server integration service 430 may be implemented, for example, at least in part as a vSphere™ integration service. The virtualization management server integration service 430 makes a secure connection 435 to a template processing agent 460 of a virtualization platform 450, for example, using mTLS (Mutual Transport Layer Security) and certificates and a software development kit embedded in the virtualization management server integration service 430 to perform the necessary API calls to the template processing agent 460 with the appropriate payloads and parameters.

In some embodiments, the template processing agent 460 can be implemented, for example, using a container and/or a virtual machine and acts as an integration agent for orchestration engine 420.

If the template processing agent 460 determines that the indicated template is not available in the inventory of the virtualization platform 450, the template processing agent 460 will request the template from the orchestration engine 420, using a connection 440-1, or from a remote storage 456 identified by the provided storage location of the template, using a connection 440-2. The orchestration engine 420 and/or the remote storage 456 provide the requested template, using a connection 445-1 or 445-2, respectively. In some embodiments, the contents of the requested template may be signed and verified.

Once the template processing agent 460 obtains the requested template, the template processing agent 460 may cache the requested template and/or upload the requested template into the inventory of the virtualization platform 450, for example, using an application programming interface 455 of the virtualization platform 450 by means of a connection 458.

In addition, the template processing agent 460 provides the obtained template to the host device 462, for example, by writing 464 the template using one or more write operations. In the example of FIG. 4, the host device 462 comprises a kernel-level write interception and verification module 465 that comprises a proxy IO layer 475 and a template signature verifier 470, in a similar manner as the kernel-level write interception and verification module 104 of FIG. 2. The proxy IO layer 475 comprises a hash calculator 478 that, in some embodiments, calculates a hash value (or another file-dependent value) of the template being written to the host device 462. The template signature verifier 470, in some embodiments, performs a hash value inspection 480 by obtaining the comparing the hash value calculated by the hash calculator 478 to one or more designated hash values (e.g., hash values associated with one or more designated (e.g., approved or authorized) templates).

The proxy IO layer 475 reads and/or writes 485 templates using one or more read and/or write operation to obtain templates (or portions thereof) from a template storage 490 and/or to store templates (or portions thereof) in the template storage 490, respectively.

As noted elsewhere herein, based on a result of the hash value inspection 480 (e.g., when the hash value calculated by the hash calculator 478 does not match one or more designated hash values), one or more automated actions may be performed such as generating at least one notification; deleting the template (or a portion thereof) from the template storage 490; preventing access to the template (or a portion thereof) in the template storage 490; and limiting access to the template (or a portion thereof) in the template storage 490.

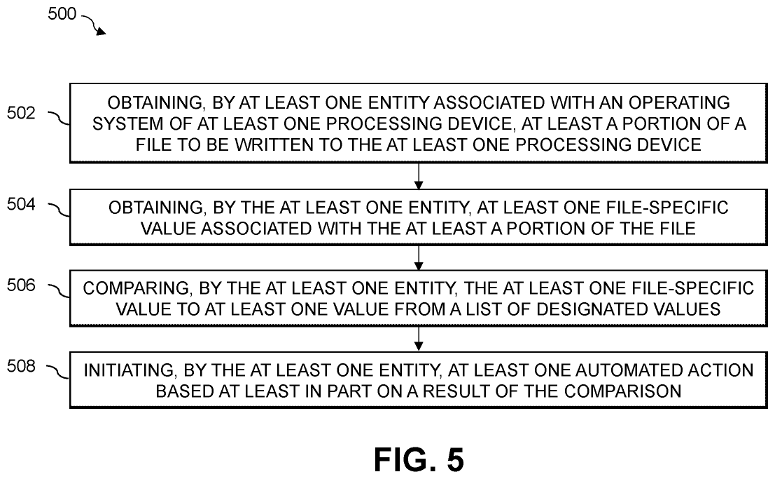

FIG. 5 is a flow diagram illustrating an exemplary implementation of a file protection process 500 using write operation interception and file verification in an illustrative embodiment. In the example of FIG. 5, the process 500 includes steps 502 through 508. These steps are assumed to be performed, for example, by the kernel-level write interception and verification module 104. The process begins at step 502, where at least one entity associated with an operating system of at least one processing device obtains at least a portion of a file to be written to the at least one processing device. In step 504, the at least one entity obtains at least one file-specific value associated with the at least a portion of the file.

The at least one entity compares the at least one file-specific value to at least one value from a list of designated values in step 506. In step 508, the at least one entity initiates at least one automated action based at least in part on a result of the comparison.

In some embodiments, the at least one automated action may comprise, for example, writing the at least a portion of the file to at least one file system (e.g., when the at least one file-specific value matches at least one value from the list of designated values); generating at least one notification (e.g., an alert); deleting the at least a portion of the file from a file system of the at least one processing device; preventing access to the at least a portion of the file; and/or limiting access to the at least a portion of the file.

In one or more embodiments, the at least one file-specific value associated with the at least a portion of the file comprises a hash value calculated in response to receiving a request to write the at least a portion of the file to the at least one processing device. The file may comprise, for example, a template for a virtual machine and/or a container, and the template may be stored in an inventory of the at least one processing device. The list may comprise a list of file-specific values associated with one or more designated files.

In at least one embodiment, the at least one entity obtains the at least a portion of the file to be written to the at least one processing device by intercepting a request to write the at least a portion of the file to the at least one processing device. The at least one entity associated with the operating system may comprise at least one software entity associated with an operating system kernel. The at least one processing device may comprise a host device and/or at least one virtual resource executing on a hypervisor.

The particular processing operations and other system functionality described in conjunction with the flow diagram of FIG. 5 is presented by way of illustrative example only, and should not be construed as limiting the scope of the disclosure in any way. Alternative embodiments can use other types of processing operations for file protection using evaluation of file-specific values. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Advantageously, the file protection techniques described herein secure the downloading of virtual resource templates and other executable files by controlling the download process from a lower kernel layer. In this manner, a more granular level of control is provided over the downloaded files by verifying the authenticity of files before they are allowed to run (or to be accessed).

A compliance and auditing mechanism may be provided in some embodiments, to track and monitor file downloads and/or an execution of such downloaded files, providing a detailed record of all activity. This added layer of oversight and accountability helps to ensure that a given device, or cluster of devices, is being used in a compliant and secure manner, and that any suspicious or unauthorized activity is detected and addressed in a timely manner.

In one or more embodiments, a given device, or cluster of devices, may be continuously monitored for suspicious activity or behavior, thereby allowing for real-time detection and response to potential security threats. This feature enables the system to be more proactive in identifying and mitigating potential risks, rather than simply reacting to security breaches after they have occurred.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for file protection using evaluation of file-specific values will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100 in FIG. 1. The cloud infrastructure 600 comprises multiple VMs and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 604, where the hypervisor platform has an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for file protection using evaluation of file-specific values as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, container orchestrators, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining, by at least one entity associated with an operating system of at least one processing device, at least a portion of a file to be written to the at least one processing device;
obtaining, by the at least one entity, at least one file-specific value associated with the at least a portion of the file;
comparing, by the at least one entity, the at least one file-specific value to at least one value from a list of designated values; and
initiating, by the at least one entity, at least one automated action based at least in part on a result of the comparison;
wherein the method is performed by at least one processing device comprising a processor coupled to a memory.

2. The method of claim 1, wherein the at least one automated action comprises one or more of writing the at least a portion of the file to at least one file system; generating at least one notification; deleting the at least a portion of the file from a file system of the at least one processing device; preventing access to the at least a portion of the file; and limiting access to the at least a portion of the file.

3. The method of claim 1, wherein the file comprises a template for one or more of a virtual machine and a container, and further comprising storing the template in an inventory of the at least one processing device.

4. The method of claim 1, wherein the at least one file-specific value associated with the at least a portion of the file comprises a hash value calculated in response to receiving a request to write the at least a portion of the file to the at least one processing device.

5. The method of claim 1, wherein the list comprises a list of file-specific values associated with one or more designated files.

6. The method of claim 1, wherein the at least one entity obtains the at least a portion of the file to be written to the at least one processing device by intercepting a request to write the at least a portion of the file to the at least one processing device.

7. The method of claim 1, wherein the at least one processing device comprises one or more of a host device and at least one virtual resource executing on a hypervisor.

8. The method of claim 1, wherein the at least one entity associated with the operating system comprises at least one software entity associated with an operating system kernel.

9. An apparatus comprising:
at least one processing device comprising a processor coupled to a memory;
the at least one processing device being configured to implement the following steps:
obtaining, by at least one entity associated with an operating system of at least one processing device, at least a portion of a file to be written to the at least one processing device;
obtaining, by the at least one entity, at least one file-specific value associated with the at least a portion of the file;
comparing, by the at least one entity, the at least one file-specific value to at least one value from a list of designated values; and
initiating, by the at least one entity, at least one automated action based at least in part on a result of the comparison.

10. The apparatus of claim 9, wherein the at least one automated action comprises one or more of writing the at least a portion of the file to at least one file system; generating at least one notification; deleting the at least a portion of the file from a file system of the at least one processing device; preventing access to the at least a portion of the file; and limiting access to the at least a portion of the file.

11. The apparatus of claim 9, wherein the file comprises a template for one or more of a virtual machine and a container, and further comprising storing the template in an inventory of the at least one processing device.

12. The apparatus of claim 9, wherein the at least one file-specific value associated with the at least a portion of the file comprises a hash value calculated in response to receiving a request to write the at least a portion of the file to the at least one processing device.

13. The apparatus of claim 9, wherein the list comprises a list of file-specific values associated with one or more designated files.

14. The apparatus of claim 9, wherein the at least one entity obtains the at least a portion of the file to be written to the at least one processing device by intercepting a request to write the at least a portion of the file to the at least one processing device.

15. The apparatus of claim 9, wherein the at least one entity associated with the operating system comprises at least one software entity associated with an operating system kernel.

16. A non-transitory processor-readable storage medium having stored therein program code of one or more software programs, wherein the program code when executed by at least one processing device causes the at least one processing device to perform the following steps:
obtaining, by at least one entity associated with an operating system of at least one processing device, at least a portion of a file to be written to the at least one processing device;
obtaining, by the at least one entity, at least one file-specific value associated with the at least a portion of the file;
comparing, by the at least one entity, the at least one file-specific value to at least one value from a list of designated values; and
initiating, by the at least one entity, at least one automated action based at least in part on a result of the comparison.

17. The non-transitory processor-readable storage medium of claim 16, wherein the at least one automated action comprises one or more of writing the at least a portion of the file to at least one file system; generating at least one notification; deleting the at least a portion of the file from a file system of the at least one processing device; preventing access to the at least a portion of the file; and limiting access to the at least a portion of the file.

18. The non-transitory processor-readable storage medium of claim 16, wherein the at least one file-specific value associated with the at least a portion of the file comprises a hash value calculated in response to receiving a request to write the at least a portion of the file to the at least one processing device.

19. The non-transitory processor-readable storage medium of claim 16, wherein the list comprises a list of file-specific values associated with one or more designated files.

20. The non-transitory processor-readable storage medium of claim 16, wherein the at least one entity obtains the at least a portion of the file to be written to the at least one processing device by intercepting a request to write the at least a portion of the file to the at least one processing device.
